(19) United States
(12) Patent Application Publication
(10) Pub. No.: US 2011/0080288 A1
(43) Pub. Date: Apr. 7, 2011

(54) PORTABLE OCCUPANT DETECTION AND NOTIFICATION SYSTEM WITH SMART SEAT CUSHION FOR USE WITH STANDARD CHILD CARSEATS

(76) Inventor: Jack M. Younse, Allen, TX (US)

(21) Appl. No.: 12/575,440

(22) Filed: Oct. 7, 2009

(51) Int. Cl. G08B 23/00

(52) U.S. Cl. 340/573.1

(57) ABSTRACT

A portable occupant detection and notification system comprised of a smart seat cushion for use with standard child carseats, a remote wireless vehicle door switch, and a wireless remote bullhorn. This system can be purchased in a box as an aftermarket product and used with any standard child carseat and any vehicle. In the preferred embodiment of the invention, the system monitors the presence of a child in the carseat, the status of at least the driver's door of the vehicle, the temperature inside the vehicle, and the status of any rechargeable batteries. The system reminds the driver by means of a voice message when leaving the vehicle that a child is onboard and further alerts the public within at least 200 feet of the vehicle when a child is left in an extreme temperature environment and needs help.

### CROSS-REFERENCE TO RELATED APPLICATIONS

This invention is related to the invention disclosed and claimed in U.S. Pat. No. 7,012,533 Granted on Mar. 14, 2006 and titled “OCCUPANT DETECTION AND NOTIFICATION SYSTEM FOR USE WITH A CHILD CAR SEAT,” the contents of which are hereby incorporated by reference in this application.

### DESCRIPTION OF THE DRAWINGS

The invention will be better understood and objects other than those set forth above will become apparent when consideration is given to the following detailed description thereof. Such description makes reference to the annexed drawings wherein:

FIG. 1 is a view showing the three major components of the present invention.

FIG. 2 is a view illustrating the present invention as an aftermarket standalone type system for use with standard child carseats and various vehicles.

FIG. 3 is a top view of the preferred embodiment of the portable occupant detection and notification system of the present invention illustrating a removable carseat cushion installed in standard child carseat, a wireless front driver's door switch, and a remote wireless bullhorn all installed in a vehicle in accordance with the principles of the present invention.

FIG. 4 is a perspective view of a standard child carseat fitted out with an attached removable carseat cushion in accordance with the principles of the present invention.

FIG. 5 is a top view showing the structure and components of the removable carseat cushion in accordance with the principles of the present invention.

FIG. 6 is a perspective view of the removable carseat cushion, which can be attached in the seat area of any child carseat, in accordance with the principles of the present invention.

FIG. 7 is a block diagram illustrating the overall inner workings of the removable seat cushion assembly in accordance with the principles of the present invention.

FIG. 8 is a block diagram illustrating the wireless paths between the removable carseat cushion assembly, the wireless door switch, and the remote wireless bullhorn in accordance with the principles of the present invention.

FIG. 9 is a block diagram illustrating the operation of the wireless door switch in accordance with the principles of the present invention.

FIG. 10 is a block diagram illustrating the functionality of the remote wireless bullhorn in accordance with the principles of the present invention.

and

FIG. 11 is an operational flowchart illustrating the overall functionality for the preferred embodiment in accordance with the principles of the present invention.

The same reference numerals refer to the same parts throughout the various figures.

### DESCRIPTION OF THE PREFERRED EMBODIMENT

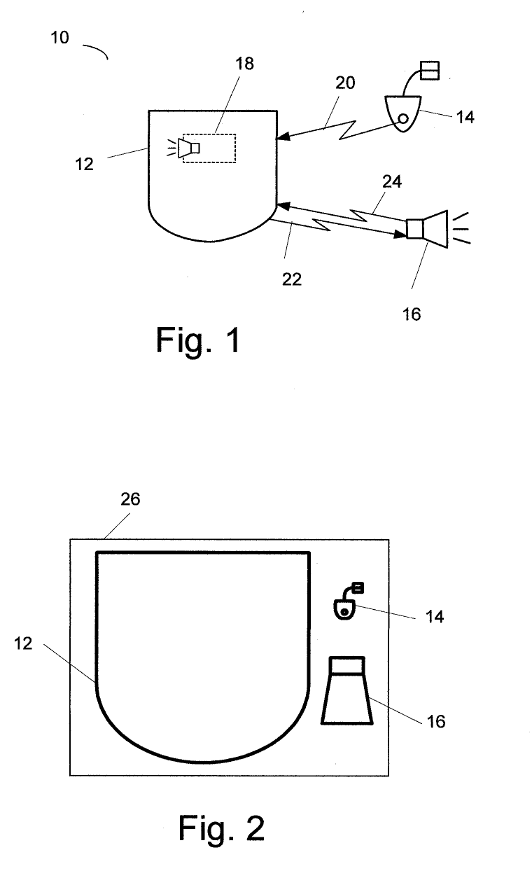

Referring now to the drawings, and particularly to FIGS. 1-11, a preferred and other embodiments of the portable occupant detection and notification system with removable seat cushion of the present invention are shown and generally designated by the reference numeral 10.

In FIG. 1, a new and preferred embodiment of the portable occupant detection and notification system 10 of the present invention, which is operationally independent of any child carseat and/or vehicle, is shown. Further, this system requires no operational input on the part of the adult occupants of the vehicle except the charging of a battery, as typically done with cell phones and digital cameras, when verbally prompted to do so. The portable occupant detection and notification system of the present invention is comprised of a carseat cushion assembly 12 with embedded control electronics 18, a wireless vehicle door switch assembly 14 that communicates with the control electronics 18 by means of transmission path 20, and a wireless remote bullhorn assembly 16 that communicates with the control electronics 18 by means of both a receiving path 22 and a transmission path 24.

In FIG. 2, a view illustrating that the present invention is a standalone system relative to standard child carseats and/or various vehicles whose three major components, a removable carseat cushion assembly 12, a wireless door switch assembly 14, and a wireless remote bullhorn assembly 16 can be purchased in a box 26 from a store or off the web and easily and quickly installed in any standard child carseat and vehicle. This approach is expected to accelerate getting these type systems in use and thereby saving children's lives.

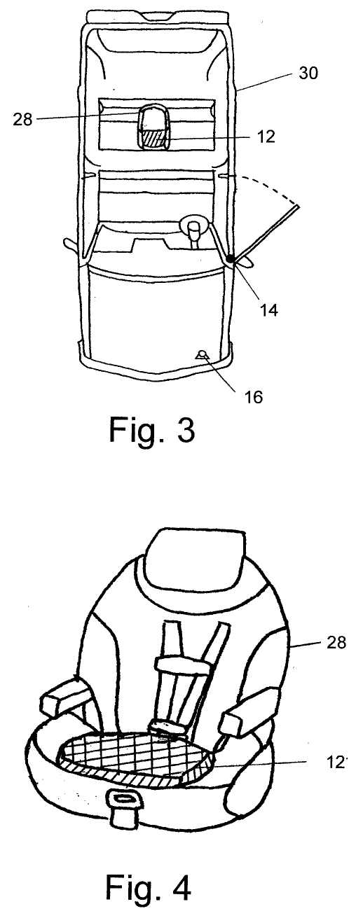

In FIG. 3, a new and preferred embodiment of the portable occupant detection and notification system with removable seat cushion assembly 12, constructed in accordance with the principles of the present invention, is illustrated and will be described. More particularly, the portable occupant detection and notification system is comprised of a removable carseat cushion assembly 12 attached in the seat area of a typical child carseat 28, which is installed in a vehicle 30. Furthermore, a wireless door switch assembly 14 is attached by suitable attaching means to or near the door post of the front-left driver's door of the vehicle so as to functionally communicate with a receiver located in the removable seat cushion assembly 12. Finally, a wireless remote bullhorn assembly 16 is mounted under the hood or other suitable location on the vehicle 30 so as to functionally communicate with a transceiver located in the removable seat cushion assembly 12. This bullhorn is very loud and clearly audible to pedestrians in large shopping center parking lots or other outside parking facilities or the like.

FIG. 4 is a perspective view of a standard child carseat 28 configured with an attached portable carseat cushion assembly 12 in accordance with the principles of the present invention. The removable carseat cushion assembly 12 is soft with a small embedded electronic package inside. The cushion can be manufactured in different shapes, sizes, and colors to be compatible with the various carseats on the market. Since the child will sit on top of the removable seat cushion assembly 12 and be strapped in, it is only necessary that the cushion be attached in the carseat such that it won't fall out when the seat is empty. This is accomplished by a number of attaching means, such as hook and loop, straps, snaps or ties.

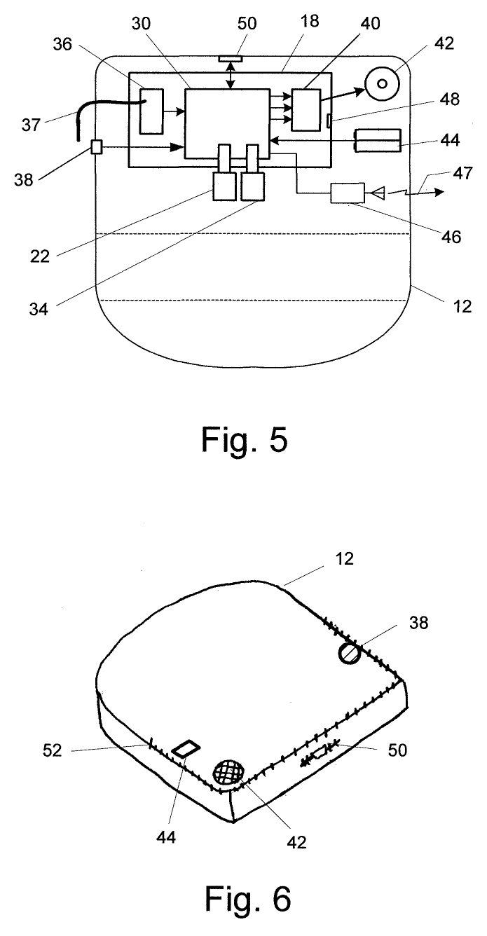

FIG. 5 is a top view showing the components that are embedded inside the removable carseat cushion assembly 12. An electronic subassembly 18 is comprised of a system microcontroller 30 with peripheral inputs from a power switch 22, a child occupancy switch 34, a temperature sensor 38, and a wireless driver's door switch assemble 14 via receiver 36 with antenna 37. Output signals from the microcontroller include inputs to an internal speech module/amplifier 40 and associated speaker 42 to remind the driver “to remember the child” when leaving the vehicle and of the need to recharge the seat cushion battery and/or bullhorn battery when low, as well as an output to a bullhorn transmitter 46 to send a wireless signal 47 to the wireless remote bullhorn assembly to trigger the urgent and loud “please rescue child from hot or cold vehicle” message. The system also provides a system ready signal by means of an indicator, such as a beeper 48 when the system is armed to indicate that system initialization is complete. Additional peripheral interfaces with the electronic subassembly 18 include a connector 50 for interfacing with an external computer for programming, troubleshooting, and debugging the system and a rechargeable battery 44 for supplying power to the carseat cushion. In addition to controlling the entire portable occupant detection and notification system, the cushion's electronic subassembly 18 keeps the driver and other occupants of the vehicle aware of the child's heat related environmental safety at all times.

FIG. 6 is a perspective view of the portable carseat cushion assembly 12, which can be attached in the seat area of any child carseat. The removable cushion of the present invention is an attractive cushion or pillow, which can be made “plain” to “high fashion.” It can be made from waterproof material and has a zipper 52 most the way around the cushion, such that the cover can be removed for washing or to gain access to the internal electronics or even to be replaced if needed. Easy access to peripheral components such as the rechargeable battery 44, temperature sensor 38, internal speaker 42, and external computer interface connector 50 are provided. The cushion can be attached in the carseat with any number of attaching means, such as hook and loop, straps, snaps, or ties to prevent it from falling out when the seat is empty.

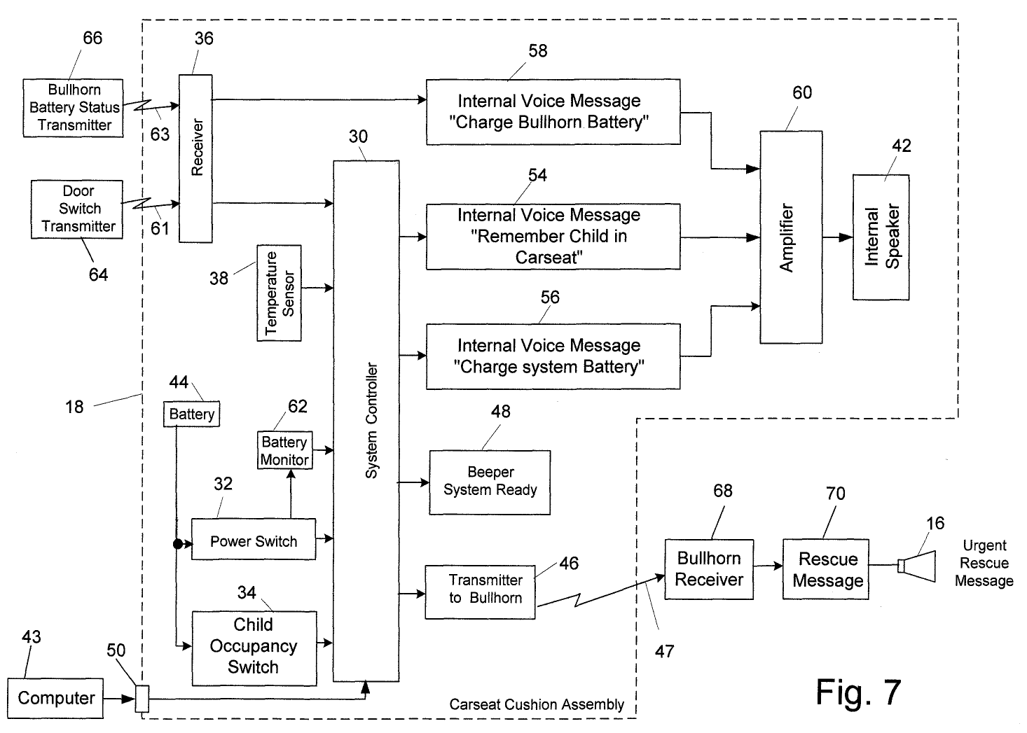

FIG. 7 is a block diagram illustrating the overall inner workings for the preferred embodiment of the portable carseat cushion assembly 12 components relative to the overall system 10. The system control circuitry 30, which consists of a microcontroller and other supporting electronic circuitry, is central to controlling the entire system. Inputs to the system control circuitry 30 are comprised of one or more door switch status signals, including at least the driver's door, which is routed from a wireless door switch transmitter 64 by means of wireless link 61 to one input of a receiver 36, located in the seat cushion assembly 12, and then to one input of the system control circuitry 30, the output from a temperature sensor 38, outputs from a power switch 32 and child occupancy switch 34, both of which are enabled only when a child is in the carseat, and a cushion battery monitor 62. Overall power is typically supplied to the cushion by means of a rechargeable battery 44 located within the carseat cushion assembly 12, although the system can operate from any power source in the range of +6 to 16 volts. Outputs from the system control circuitry 30 are at least signals to trigger an internal voice message reminding occupants of the vehicle to remember the child when exiting the vehicle 54, a signal to trigger an internal voice message well before the cushion battery needs recharging 56, a signal to trigger an indicator, such as a beeper 48, when the system is initialized after placing a child in the carseat and at least the driver is in the vehicle and the driver's door is closed, and an output signal to enable a rescue bullhorn transmitter 46, indicating when extreme temperature conditions exist inside the vehicle with a child in the carseat. When extreme temperature conditions exists, a radio frequency signal 47 is then sent from the bullhorn transmitter 46 to a remotely located bullhorn receiver 68, which triggers a recorded rescue message 70 and sends it to the wireless remote bullhorn assembly 16, which includes a very loud speaker to alert anyone in a wide vicinity of the vehicle that urgent rescue is needed. The wireless remote bullhorn 16 typically operates from a contained rechargeable battery, which is enabled only when there is a need to broadcast rescue messages, but optionally could also be operated from the vehicle's battery. In the general case where the bullhorn is operated from a contained rechargeable battery, a battery status RF signal 63 is sent by means of a bullhorn battery status transmitter 66 to a second input of the carseat cushion receiver 36 to trigger an internal voice message 58 regarding the need to recharge the bullhorn battery. The outputs from the internal voice message 54 to “remember the child” when exiting the vehicle, the internal voice message 56 regarding the need to recharge the cushion battery, and the internal voice message 58 regarding the need to recharge the bullhorn battery are coupled to inputs of an audio amplifier 60, whose output is then coupled to an internal carseat cushion speaker 42. Power to portions of this circuitry is only applied when a message is about to be sent. Finally, a computer 43 interface connector 50 is coupled into the system control circuitry 30 for use in programming, troubleshooting, and debugging the system, which is usually carried out by a service rep or other person who is knowledgeable of the system's operation.

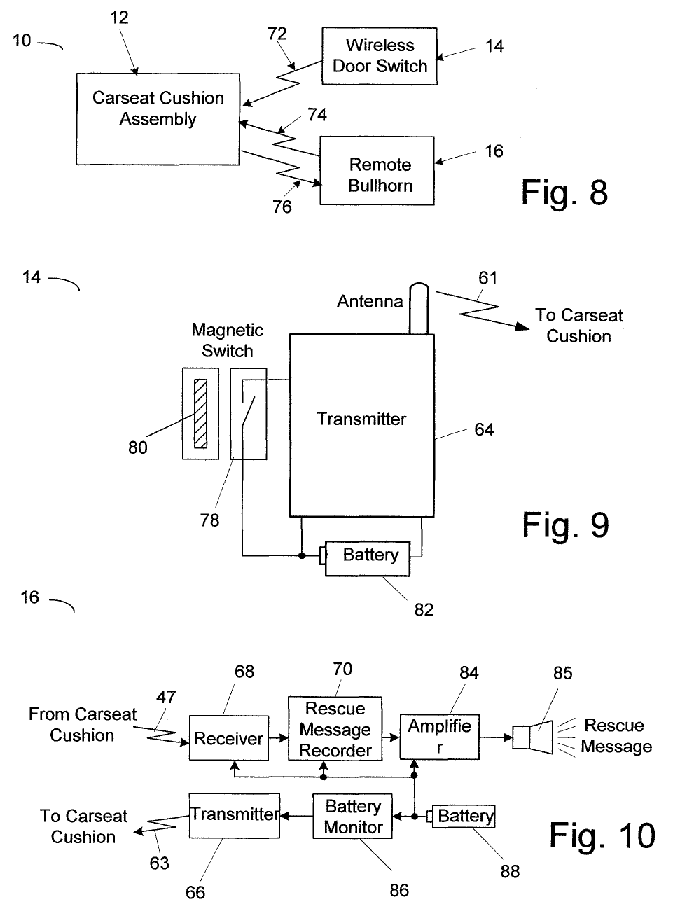

FIG. 8 is a block diagram illustrating the wireless paths between the carseat cushion assembly 12, the wireless vehicle door switch assembly 14, and the wireless remote bullhorn assembly 16. The wireless door switch assembly 14 only has one way communication with the carseat cushion assembly 12 in that it transmits 72 a signal only when the driver's door, or optionally other doors if desired, is open. On the other hand, the wireless remote bullhorn assembly 16 is capable of two-way communications with the carseat cushion assembly 12 with the carseat cushion assembly transmitting 76 to the bullhorn when a distress signal is warranted and the bullhorn transmitting 74 to the carseat assembly well before the remote bullhorn battery needs charging. The bullhorn will only draw current from the battery when it is activated to sound a distress message or to check the internal battery status. Optionally, the bullhorn can be connected to the vehicle's battery.

FIG. 9 is a block diagram illustrating the operation of the wireless vehicle door switch assembly 14 in accordance with the principles of the present invention. In the preferred embodiment of the invention this assembly has a magnetic switch assembly, which is comprised of an electrical switch 78 that is enabled by means of a permanent magnet 80, coupled to a transmitter 64 with antenna. When the door is open the transmitter sends an RF signal 61 to receiver 36 in the carseat cushion's embedded control electronics 18. Power to the wireless vehicle door switch assembly 14 is typically provide by means of a very long life battery 82 with LED light indicator, such as can be found in typical garage door opener key fobs. The switch portions of this assembly can also be accomplished using other means including but not limited to an IR switch or a MEMS device switch.

FIG. 10 is a block diagram illustrating the functionality of the wireless remote bullhorn assembly 16 in accordance with the principles of the present invention. In the preferred embodiment of the present invention a bullhorn receiver 68 receives a RF signal 47 from the carseat cushion indicating that a rescue message needs to be broadcast. This in turn triggers the bullhorn rescue message recorder 70, which is coupled to a bullhorn amplifier 84 whose output is coupled to the bullhorn speaker 85. Furthermore, in the preferred embodiment of the present invention where the bullhorn assembly is powered by means of a rechargeable battery 88, a battery monitor circuit 86 and transmitter 66 is provided to send a RF signal 63 back to the receiver 36 located in the carseat cushion's control electronics subassembly 18.

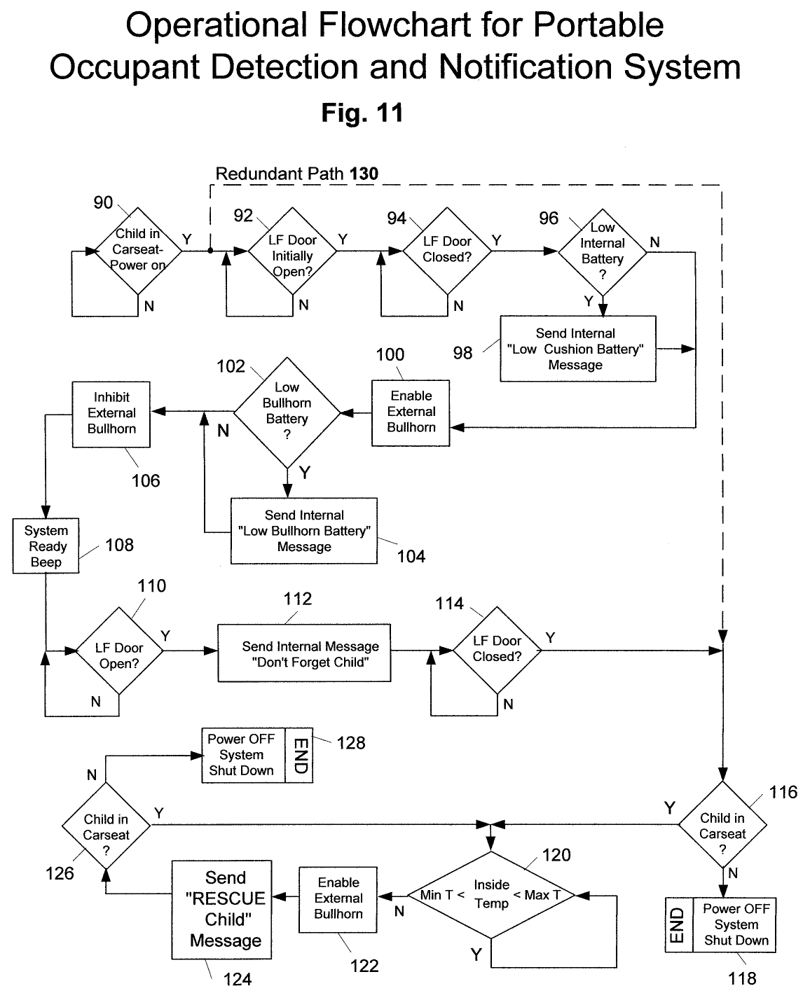

FIG. 11 is an operational flowchart illustrating the overall functionality for the preferred embodiment of the present invention. The operational flow begins when a child is placed in the carseat 90, sitting on the carseat cushion, thereby enabling the power and child occupancy switches. The system waits for the left front (LF) driver's door to be initially opened 92 and then closed 94, thereby allowing the driver to get in the vehicle without interfering with the system. The status of the internal cushion battery is then checked 96 and a low cushion battery message 98 is sent if the battery needs charging. If not, power to the remote bullhorn is enabled 100 and the bullhorn battery status is checked 102 and an internal bullhorn message 104 is sent if the battery needs charging, otherwise the remote bullhorn is inhibited 106. The system then sends an internal system ready signal 108, such as a short beep, indicating the system is armed and functioning properly. The system then remains quiet while the vehicle is travelling, always watching for the LF driver's door to open 110, normally indicating that the vehicle has stopped and the driver is exiting. Then the system sends an internal “don't forget child” message 112 to remind the diver to take the child out of the vehicle. The system then waits for the LF door to close 114 and then checks to see if the child is still in the carseat 116. If the child is not in the carseat, the power is OFF 118 and the system is shutdown. However, if the child is still in the carseat this indicates that he or she has possibly been abandoned in a dangerous environment and the system continuously monitors the inside vehicle temperature 120 to assure that it remains in a safe range. A typical temperature range might be from 50° F. to 90° F., although this range can be set to any desired value in software. Once the temperature is outside the preset safe range, the remote bullhorn is enabled 122 and the system sends a loud bullhorn RESCUE child message 124 and then checks to see if the child is still in the carseat 126. If the child is still in the carseat the system cycles back to the temperature monitoring function 120 and continues this loop until the child is rescued. Once the child is removed from the carseat the power is off and the system is automatically shutdown 126.

The carseat cushion system also has a parallel redundant fail-safe parallel mode 130 that overlays the regular system flow path. The purpose of this path is to continuously monitor the temperature inside the vehicle as long as a child is in the carseat regardless of the state of door(s), driver, or other aspects of the system. If the temperature inside the vehicle exceeds the upper or lower temperature limit at any time, a RESCUE message is sounded from the bullhorn until help arrives and removes the child from the carseat. For example, if something happens to the driver while he or she is still in the vehicle and the temperature becomes too hot or cold, the RESCUE message will continue to sound until help arrives regardless of the circumstances.

Since the portable occupant detection and notification system of the present invention is capable of being installed in a child carseat and vehicle without any modifications to the associated carseats or vehicles it is important that in the preferred embodiment of the invention the system be battery operated. To this end, close attention is given to power management in the preferred embodiment of the present invention. First, the system dissipates zero power except when a child is in the carseat. Second, power is only applied to certain items, such as selected circuitry relating to voice messages and the wireless remote bullhorn assembly when these functions are needed. Other selected functions can also be put in the “snooze or sleep” mode in software as desired to further conserve power. Furthermore, during system power up, the voltage of all rechargeable batteries is check and an internal voice message notifies the vehicle's driver when a battery needs recharging well before the voltage reaches a critical level.

Typically, rechargeable batteries with a sharp voltage drop-off knee, such as Lithium-ion batteries, like those used in cell phones and digital cameras are desirable.

A major advantage of the preferred embodiment of the portable occupant detection and notification system with removable seat cushion of the present invention is that there are no modification or additions required to the child carseat or to the vehicle. The system can be purchased in a box at various stores or ordered off the web and then easily and quickly be placed in service in any child carseat and vehicle. The system can be operated virtually hands-off with the exception of charging a battery when alerted to do so. The assemblies are typically battery powered with rechargeable batteries, such as used with cell phones or digital cameras, and require no power until a child in positioned in the carseat. Optionally, the system can be powered by a vehicle's power system. Furthermore, power is only turned on to selected portions of the system for very short durations when needed. The system's wireless functions will typically operate at 433 MHz frequency, like used in applications such as garage door openers and require no certification. However, other frequencies can be used where desired. The system will be affordable, reliable, easy to install and operate and will save lives.

Finally, the system's three majors assemblies, the embedded portion of the carseat cushion assembly 12, the wireless vehicle door switch assembly 14, and wireless remote bullhorn assembly 16 can also be integrated as an integral portion of future carseats. Furthermore, all components could be integrated as integral parts of future vehicles.

While a preferred embodiment of the occupant detection and notification system has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. For example, the operational flowchart given for the preferred embodiment of the invention is given as a typical mode of operation, but other desired operational sequences can be provide simply by changing the software code and downloading it into the carseat cushion's microcontroller's read only memory via the external computer interface connector. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for detecting when a child is abandoned in an extremely hot or cold vehicle environment and sending a loud rescue message, comprising:
a carseat cushion assembly, said cushion assembly being secured in a standard child carseat, said cushion assembly comprising:
a microcontroller for overall control of said system;
a power source for supplying power to said cushion assembly, said power source being enabled when said child is placed in said child carseat;
a child detection means being coupled to a first input of said microcontroller, said detection means involving a carseat cushion pressure switching means located near the center of said carseat cushion, said switching means being enabled when said child is placed in said child carseat;
an inside vehicle temperature sensor being coupled to a second input of said microcontroller for detecting when the temperature inside said vehicle is above or below a predetermined safe temperature range;
an internal voice message means being coupled to a first output of said microcontroller for communicating with occupants of said vehicle regarding the status of said system; and
a transceiver for communicating with other remote components of said system;
a remote wireless vehicle door switch assembly, said door switch assembly being secured by mounting means on driver's door post of said vehicle, said door switch assembly comprising:
a door transmitter for communicating with a first receiver of said transceiver of said carseat cushion assembly; and
a switch means for triggering said door transmitter when said vehicle's driver door is opened;
a remote wireless bullhorn assembly for sounding a distress message when said child is in danger inside said vehicle, said bullhorn assembly comprising:
a receiver for receiving a signal from a transmitter of said carseat cushion transceiver;
a voice message means for storing a distress message; and
a high volume speaker for broadcasting said distress message.

2. The system of claim 1, wherein said carseat cushion assembly is secured by attaching means in the seat area of any standard child carseat.

3. The system of claim 1, wherein said carseat cushion assembly is powered by means of a rechargeable battery, said power source being enabled by a carseat cushion pressure switch means.

4. The system of claim 3, wherein said carseat cushion assembly further comprises a rechargeable battery monitoring capability with voice message to said vehicle driver when said battery needs recharging.

5. The system of claim 1, wherein said internal voice message means is further comprised of:
a memory for storing recorded messages;
an amplifier; and
a speaker for broadcasting messages.

6. The system of claim 1, wherein said carseat cushion assembly has an internal notification means, such as a beeper, to indicate when the system is armed and operating normally.

7. The system of claim 1, wherein said carseat cushion assembly has a computer interface for use in monitoring, debugging, troubleshooting and programming said system's operation.

8. The system of claim 1, wherein said wireless bullhorn assembly is powered by means of a rechargeable battery.

9. The system of claim 1, wherein said wireless bullhorn assembly is powered by means of said vehicle's battery.

10. The system of claim 1, wherein said wireless bullhorn assembly has a transmitter for communicating with a second receiver of said carseat cushion transceiver for indicating the status of said bullhorn's rechargeable battery.

11. The system of claim 1, wherein said carseat cushion assembly has a factory preset safe operating temperature range.

12. The system of claim 11, wherein said safe operating temperature range can be changed by means of software code of said microcontroller.

13. A carseat cushion assembly for detecting when a child is abandoned in an extremely hot or cold vehicle, said cushion assembly being capable of communicating with a wireless vehicle door switch and with a wireless remote bullhorn for purposes of detecting extreme environments inside said vehicle and notifying public by means of repeatedly sending a loud distress message, said cushion assembly suitable for securing by attaching means in the seat area of any standard child carseat, comprising:
a microcontroller;
a power source for supplying power to said cushion assembly, said power source being enabled when said child is placed in said child carseat;
a child detection means being coupled to a first input of said microcontroller, said detection means involving a carseat cushion pressure switching means located near the center of said carseat cushion assembly, said pressure switching means being enabled when said child is placed in said child carseat;
an inside vehicle temperature sensor being coupled to a second input of said microcontroller for detecting when the temperature inside said vehicle is above or below a predetermined safe temperature range;
an internal voice message means being coupled to a first output of said microcontroller for communicating with occupants of said vehicle regarding the status of said child's safety; and
a transceiver for communicating with other remote components of a child rescue system.

14. The assembly of claim 13, wherein said carseat cushion assembly is powered by means of a rechargeable battery.

15. The assembly of claim 13, wherein said carseat cushion assembly further comprises a rechargeable battery monitoring capability with voice message to said vehicle's driver when said battery needs recharging.

16. The assembly of claim 13, wherein said internal voice message means is further comprised of:
a memory for storing recorded messages;
an amplifier; and
a speaker for broadcasting messages.

17. The assembly of claim 13, wherein said carseat cushion assembly has a computer interface for use in monitoring, debugging, troubleshooting, and programming said cushion assembly's operation.

18. The assembly of claim 17, wherein said carseat cushion assembly has a factory preset safe operating temperature range, said safe operating temperature range capable of being changed through said computer interface.

19. A method for detecting and notifying that a child is abandoned in an extremely hot or cold vehicle, comprising:
providing a system for detecting when said child is abandoned in said hot or cold vehicle environment and sending a loud rescue message, comprising:
a carseat cushion assembly, said cushion assembly being secured in a standard child carseat, said cushion assembly further comprising:
a microcontroller for overall control of said system;
a power source for supplying power to said cushion assembly, said power source being enabled when said child is placed in said child carseat;
a child detection means being coupled to a first input of said microcontroller, said detection means involving a carseat cushion pressure switching means located near the center of said carseat cushion assembly, said switching means being enabled when said child is placed in said child carseat;
an inside vehicle temperature sensor being coupled to a second input of said microcontroller for detecting when the temperature inside said vehicle is above or below a predetermined safe temperature range;
an internal voice message means being coupled to a first output of said microcontroller for communicating with occupants of said vehicle regarding the status of said system;
a transceiver for communicating with other remote components of said system; and
a rechargeable battery;
a remote wireless vehicle door switch assembly, said door switch assembly being secured by mounting means on driver's door post of said vehicle, said door switch assembly comprising:
a door transmitter for communicating with a first receiver of said transceiver of said carseat cushion assembly; and
a switch means for triggering said door transmitter when said vehicle's driver door is opened;
a remote wireless bullhorn assembly for sounding a distress message when said child is in danger inside said vehicle, said bullhorn assembly further comprising:
a receiver for receiving a signal from a transmitter of said carseat cushion transceiver;
a voice message means for storing a distress message;
a high volume speaker for broadcasting said distress message; and
a rechargeable battery;
performing the operational functions of said system, said functions being comprised of:
step 1, determining when a child occupies said child carseat by monitoring the state of said cushion pressure switching means;
step 2, enabling said system once responsible occupants are in said vehicle and all door(s) are closed by means of monitoring the state of said wireless vehicle door switch assembly;
step 3, monitoring the status of said carseat cushion's said rechargeable battery, thereby sending an internal charge battery voice message when said battery needs recharging;
step 4, sounding an audible sound indicating when system is armed and operating normally;
step 5, detecting when said driver's door of said vehicle is opened, by means of monitoring the state of said remote wireless vehicle door switch assembly;
step 6, enabling said internal voice message means reminding that said child is still strapped in said child car seat;
step 7, inhibiting said system if said child is removed from said child car seat, as determined by monitoring the state of said cushion pressure switching means;
otherwise, if said child is left unattended in said child car seat:
step 8, sensing the internal temperature inside said vehicle by means of monitoring said inside vehicle temperature sensor;
step 9, continuously sounding a loud external distress message from said remote wireless bullhorn assembly that said child is in danger inside said vehicle, until someone comes to the aid of said child, when said vehicle's inside temperature reaches an unsafe temperature; and
step 10, turning off power to said system when said child is safely removed from said vehicle.

20. The method of claim 19, wherein said system has a redundant mode of operation overriding normal operation so that if said child is in said vehicle in an unsafe temperature environment, regardless of all other aspect of said system, then a loud external distress message from said bullhorn assembly will continuously be sounded until someone comes to the aid of said child and removes him or her from said vehicle.
